(19) United States
(12) Patent Application Publication
(10) Pub. No.: US 2011/0282787 A1
(43) Pub. Date: Nov. 17, 2011

(54) MONEY TRANSFER SYSTEM AND METHOD

(76) Inventors: Nicholas Birdseye, South Australia (AU); Mak Pont, South Australia (AU)

(21) Appl. No.: 13/130,791

(22) PCT Filed: Sep. 11, 2009
(86) PCT No.: PCT/AU2009/001206

§ 371 Date: May 24, 2011

(30) Foreign Application Priority Data
Sep. 12, 2008 (AU) 2008904758

(51) Int. Cl. G06Q 40/00

(52) U.S. Cl. 705/43

(57) ABSTRACT

A monetary linking system (MLS) allowing real-time arid non-real-time linking of funds from a source bank account to one or more destination bank accounts. This system allows the owner of the destination account (the intended receiver) to access linked funds immediately by depositing them into their account via current and future banking services (i.e. online bank web site, bank teller, ATM) or withdrawing them from an Automated Teller Machine (ATM), a bank teller and other current and future withdrawal services.

### FIELD OF THE INVENTION

The filed of the invention relates to banking and in particular the transfer of funds from one person to another.

### DESCRIPTION OF THE PRIOR ART

There are many ways that money can be transferred from one person to another, one of the most common ways is via the Western Union money transfer, often referred to as a wire transfer, service in which a sender needs to visit a Western Union office or Internet site, place monies to be transferred into the Western Union account and then advise the intended recipient that moneys area available fro them to withdraw from the Western Union office close to them.

The recipient then needs to usually visit the specified Western Union office, which may or may not be conveniently located for them, and provide identification details such as a driver's license to prove that they are the intended recipient. If such proof is provided then the money is transferred to them.

Problems can arise in this type of transfer if the intended recipient does not have sufficient ID at the time of attempting to access the money from the office or if the office has limited hours of availability. In some cases the closest office is in fact not convenient to the intended recipient and delays can then arise in accessing the intended funds.

### OBJECT OF THE INVENTION

It is an object of the present invention to provide a method of transferring money from a first person to second person in a remote location.

It is a further object of the invention to provide a secure system for the transfer of money from a sender to a remote receiver, the system requiring the remote receiver to provide unique personal identification in order to receive the money.

It is an object of the present invention to overcome, or at least substantially ameliorate, the-disadvantages and shortcomings of the prior art.

Other objects and advantages of the present Invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a method of transferring funds from a sender to a remote receiver, wherein the sender has available funds, the method including the steps of:

the sender communicating to a central computer server and providing transfer authorisation data;

the transfer authorisation data including an amount of money to be transferred to the remote receiver;

designating the amount of money as monies to be received by the receiver; providing a first unique security identifier (USI) to the sender;

the sender providing the intended remote receiver with the first USI;

the remote receiver then accessing an automatic teller machine (ATM) using their own access card and personal USI and providing the first USI when prompted providing access to the amount of money transferred by the sender.

The concept is a monetary linking system (MLS) allowing real-time and non-real-time linking of funds from a source bank account to one or more destination bank accounts. This system allows the owner of the destination account (the intended receiver or remote receiver) to access linked funds immediately by depositing them into their account via current and future banking services (i.e. online bank web site, bank teller, ATM) or withdrawing them from an Automated Teller Machine (ATM), a bank teller and other current and future withdrawal services.

In preference, the method includes the step of automatically computing a transfer fee and charging said transfer fee to the sender.

In preference, the method includes the step of automatically relaying the first USI to the sender by way of a mobile communications device, such as a mobile phone.

In preference, the amount of money to be transferred is transferred from the senders account to a temporary account held separately to the senders account.

The MLS system establishes a relationship between the source bank account number and the destination bank account number with an amount of funds that are available to the destination bank account number. The MLS system must have access and authority to the source bank account to ensure the linked funds can be released to the destination bank account.

An advanced MLS system shall also be able to link a source bank account number to a destination user (someone that has registered with the system and has provided one or more bank account numbers). Therefore, these funds are now linked to all bank accounts' owned by the destination user.

In preference, the first USI includes a mobile phone number of the sender.

In preference, the sender communicates or designates to the central computer server via a first ATM by making a transfer or deposit of an amount of monies and specifying details of an intended remote receiver, the central computer server then marks said monies as being reserved for said intended receiver and provides the sender with a first USI, the intended recipient then accesses a second ATM by providing their own USI, such as a magnetic swipe card and PIN, and then receives a message from the central server that an amount of money has been made available to them by the sender for them to withdraw upon input of the first USI.

Once the intended receiver account owner enters their bank or credit card into the ATM, validated ownership with a PIN and selected their account type they will be given the option to retrieve any funds linked to this account. The ATM will initiate a call to the ATM Switch requesting linked funds for this account. The ATM will direct the request to the MLS system, and the MLS system will locate all linked funds available for this account, and will return them to the ATM Switch, returning it to the ATM. Any linked funds will be displayed on the ATM Screen and will allow the user to collect these funds in cash. Upon withdrawing the cash, regular ATM settlement will occur between the holding account and the ATM owner.

In preference, the intended remote receiver is allowed access only to the amount of monies designated by the sender.

This invention covers all systems, methods and services that can be used and/or implemented to perform a linked fund payment, including payments via Simple Messaging Service (SMS), Email, Web Browsers, Internet Connected Devices and Applications, existing and future internet and physical banking services.

To support linked fund payments, the Monetary Linking Systems will have access and authorisation to one or more holding bank accounts. When making the linked fund payment, the funds will be sent to the holding account using, current payment methods. It will take between 1-3 days for the funds to be settled into the holding account. Upon making the payment, the following items need to be specified to the Monetary Linking System (MLS): The Amount, The Source Currency, The Destination Currency, The Destination Account Number, The Destination Account Owners Contact Detail (i.e. mobile, email, etc) and The Collection Availabilty (i.e. Realtime or Non-realtime). The MLS will retrieve the account number for the holding account (The Holding Account Number) that corresponds to the Destination Currency, and will establish a link between The Holding Account Number and The Destination Account Number allowing it to have access to The Amount funds. When the funds are available for collection, the destination account owner will receive an alert via sms, email, etc.

Payments can be made to the MLS via Simple Messaging Service (SMS), Email, Web Browsers, Internet Connected Devices and Applications, existing and future internet and physical banking services.

### DETAILED DESCRIPTION OF THE INVENTION

ATM's are well know as being conveniently located in many shopping areas as well as other areas that are known to have high pedestrian traffic. In addition, ATM's are open almost all the time, unlike traditional banks or shops that have business hours and thus shut down at certain time of the day/night. The use of ATM's enables account holders to easily access funds at a time and place that is most convenient to them with a minimum amount of fuss.

According to an embodiment of the invention there is provided a money transaction or money transfer method in which a first user (sender) needs to send an amount of money to a recipient (remote recipient). The sender communicates with a central server either via an Internet connection or ATM. If an Internet connection is used then access is via an internet banking site of which the sender is an-account holder.

The sender then designates an amount of money that they wish to make available for the intended recipient, for example $200, and the sender then authorizes that that amount, and that amount only, is accessible to the intended recipient.

This information is then communicated to an central computer server that then confirms that the amount of money is suitable to be transferred and then the details of the recipient are correct with that entered by the sender, this is a confirmation step.

At this point a transfer fee can be applied to the confirmation step, authorising the withdrawal of a set amount of money from the senders account to complete the transfer of money.

The central server then reserves the amount as being specifically accessible to the intended recipient and provides the sender with a unique security identification code, such as a number and confirms with the sender that the intended recipient must provide this number in order to access the monies and provides them with the USI.

The sender then communicates by an alternate means, such as a mobile phone, with the intended recipient that certain monies are available for them to collect. The intended recipient then accesses their own personal account via ATM, requiring that they first swipe their personal magnetic access card (ATM card) in order to gain access to their accounts list.

A message is then displayed on the ATM that money has been transferred to their account and that if they wish to access it they need to provide the USI. If the USI is a match for that provided to the sender by the central server then the recipient can have the option of either transferring the cash into one of their personal accounts or withdrawing the set amount of cash directly.

In practice, once the intended receiver account owner enters their bank or credit card into the ATM, validated ownership with a PIN and selected their account type they will be given the option to retrieve any funds linked to this account. The ATM will initiate a call to the ATM Switch requesting linked funds for this account. The ATM will direct the request to the MLS system, and the MLS system will locate all linked funds available for this account, and will return them to the ATM Switch, returning it to the ATM. Any linked funds will be displayed on the ATM Screen and will allow the user to collect these funds in cash. Upon withdrawing the cash, regular ATM settlement will occur between the holding account and the ATM owner.

Various modifications may be made in details of design and construction [and process steps, parameters of operation etc] without departing from the scope and ambit of the invention.

1. A method of transferring funds from a sender to a remote receiver, wherein the sender has available funds, the method including the steps of:
a. the sender communicating to a central computer server and providing transfer authorisation data input;
b. the transfer authorisation data input including an amount of money to be transferred to the remote receiver;
c. designating the amount of money as monies to be received by the receiver;
d. providing a first unique security identifier (USI) to the sender;
e. the sender providing the remote receiver with the first USI;
f. the remote receiver then accessing an automatic teller machine (ATM) and at least providing the first USI when prompted by the ATM so as to authenticate access and providing access to the amount of money transferred by the sender.

2. The method of claim 1, further including the step of automatically computing a transfer fee and charging said transfer fee to the sender.

3. The method of claim 2, further including the step of automatically relaying the first USI to the sender by way of a mobile communications device.

4. The method of claim 3, wherein the amount of money to be transferred is transferred from the senders account to a temporary account held separately to the senders account.

5. The method of claim 4, wherein the first USI includes a mobile phone number of the sender.

6. The method of claim 1, wherein the sender communicates to a central server via an ATM.

7. The method of claim 1, wherein the remote receiver accesses an ATM using a remote receiver USI.

8. The method of claim 7, further characterized in that the remote receiver USI is selected from the group of a personal identification number (PIN) and an account access card.

9. The method of claim 1, wherein the transfer authorisation data input includes at least one of the following: a source currency, a destination currency, a remote receivers account number, a remote receivers account contact detail or a collection availability.

10. (canceled)
